(19) United States
(12) Patent Application Publication
(10) Pub. No.: US 2026/0322634 A1
(43) Pub. Date: Oct. 15, 2026

(54) BLOCKCHAIN UPDATE PROCESSING METHOD, INFORMATION PROCESSING APPARATUS, INFORMATION PROCESSING SYSTEM, AND PROGRAM

(71) Applicant: FUJIFILM Corporation, Tokyo (JP)

(72) Inventors: Yuji AKADA, Kanagawa (JP); Atsushi ITO, Kanagawa (JP); Yuko MASUDA, Kanagawa (JP); Yutaka OISHI, Kanagawa (JP); Shinnosuke SONODA, Kanagawa (JP); Sae NESHIBA, Kanagawa (JP); Shohei YANO, Kanagawa (JP)

(73) Assignee: FUJIFILM Corporation, Tokyo (JP)

(21) Appl. No.: 19/683,193

(22) Filed: May 20, 2026

Related U.S. Application Data
(63) Continuation of application No. PCT/JP2024/033955, filed on Sep. 24, 2024.

(30) Foreign Application Priority Data
Nov. 24, 2023 (JP) 2023-199420

(51) Int. Cl. H04L 9/00

(52) U.S. Cl. CPC H04L 9/50; H04L 2209/08

(57) ABSTRACT

A management server checks an update command of a blockchain at each predetermined time (100 to 106), and in a case where the update command is checked when the predetermined time elapses, generates a transaction based on the update command (108, 112) and adds the transaction to the blockchain (114). On the other hand, in a case where the update command is not checked even after the predetermined time elapses, the management server generates a dummy transaction (108, 110), and performs a process of adding the generated dummy transaction to the blockchain (114).

### CROSS-REFERENCE TO RELATED APPLICATIONS

This application is a continuation application of International Application No. PCT/JP 2024/033955, filed Sep. 24, 2024, the disclosure of which is incorporated herein by reference in its entirety. Further, this application claims priority from Japanese Patent Application No. 2023-199420, filed Nov. 24, 2023, the disclosure of which is incorporated herein by reference in its entirety.

### BACKGROUND

### 1. Technical Field

The present disclosure relates to a blockchain update processing method, an information processing apparatus, an information processing system, and a program.

### 2. Related Art

WO2022/180752A proposes a control system that records information indicating transaction information and a scheduled timing for enabling the transaction information in a first blockchain (BC) in response to a record request received from a client device. In particular, a block including a scheduled timing for enabling dummy transaction information is generated and added to a first BC managed by the own node in a case where a record request is not received for a certain period.

JP2023-520632A proposes a method for protecting confidentiality and differential privacy of a blockchain ledger by intentionally introducing a noise transaction into a blockchain network.

JP2019-53712A proposes an electronic voting system composed of a first blockchain including first transaction data indicating that a voter is authenticated, and a second blockchain including second transaction data that is voting information included in voting data, and dummy transaction data that is transaction data including voting content of a dummy ballot not associated with voting by the voter.

JP2020-80498A proposes a blockchain system including a transaction network including a plurality of ordinary nodes, and a privileged node connected to the transaction network.

### SUMMARY

With the expansion of the use cases of the blockchain, various inconveniences occur because the frequency of writing to or referring to the blockchain is made public to the entire world or to users participating in the blockchain. For example, there is a concern that the technical strength, the economic situation, the fluctuation of the stock price, and the like of a certain company can be estimated from the frequency of writing to a public blockchain in the company.

The present disclosure has been made in consideration of the above-described circumstances, and an object of the present disclosure is to provide a blockchain update processing method, an information processing apparatus, an information processing system, and a program capable of making it difficult to predict an actual frequency of writing to the blockchain.

In order to achieve the above object, according to a first aspect of the present disclosure, there is provided a blockchain update processing method executed by a computer, the method comprising: checking an update command of a blockchain at each predetermined time; generating a transaction based on the update command and adding the transaction to the blockchain in a case where the update command is checked when the time elapses; generating a dummy transaction in a case where the update command is not checked even after the time elapses; and adding the generated dummy transaction to the blockchain.

According to a second aspect of the present disclosure, in the blockchain update processing method according to the first aspect, the computer measures an elapsed time and compares the elapsed time with the time to determine the elapse of the time.

According to a third aspect of the present disclosure, in the blockchain update processing method according to the first aspect, the update command is a request to add a transaction including a key and a value corresponding to the key to the blockchain.

According to a fourth aspect of the present disclosure, in the blockchain update processing method according to the first aspect, the computer generates a random value or a fictional transaction content as the dummy transaction.

According to a fifth aspect of the present disclosure, there is provided an information processing apparatus comprising: a processor, in which the processor is configured to: check an update command of a blockchain at each predetermined time; generate a transaction based on the update command and add the transaction to the blockchain in a case where the update command is checked when the time elapses; generate a dummy transaction in a case where the update command is not checked even after the time elapses; and add the generated dummy transaction to the blockchain.

According to a sixth aspect of the present disclosure, there is provided an information processing system comprising: the information processing apparatus according to the fifth aspect, and a client computer that transmits the update command to the information processing apparatus.

According to a seventh aspect of the present disclosure, there is provided a program for causing a computer to execute a process comprising: checking an update command of a blockchain at each predetermined time; generating a transaction based on the update command and adding the transaction to the blockchain in a case where the update command is checked when the time elapses; generating a dummy transaction in a case where the update command is not checked even after the time elapses; and adding the generated dummy transaction to the blockchain.

According to the present disclosure, it is possible to provide a blockchain update processing method, an information processing apparatus, an information processing system, and a program capable of making it difficult to predict an actual frequency of writing to a blockchain.

### BRIEF DESCRIPTION OF THE DRAWINGS

Exemplary embodiments according to the technique of the present disclosure will be described in detail based on the following figures, wherein:

FIG. 1 is a block diagram illustrating an example of an overall configuration of an information processing system according to the present embodiment.

FIG. 2 is a block diagram illustrating a main configuration of an electric system of a management server and a client computer in the information processing system according to the present embodiment.

FIG. 3 is a functional block diagram illustrating a functional configuration of the management server of the information processing system according to the present embodiment.

FIG. 4 is a diagram illustrating an example of a flow of update processing of a blockchain performed by the management server of the information processing system according to the present embodiment.

### DETAILED DESCRIPTION

Hereinafter, embodiments of the present invention will be described in detail with reference to the accompanying drawings. It should be noted that the present embodiment does not limit the present invention.

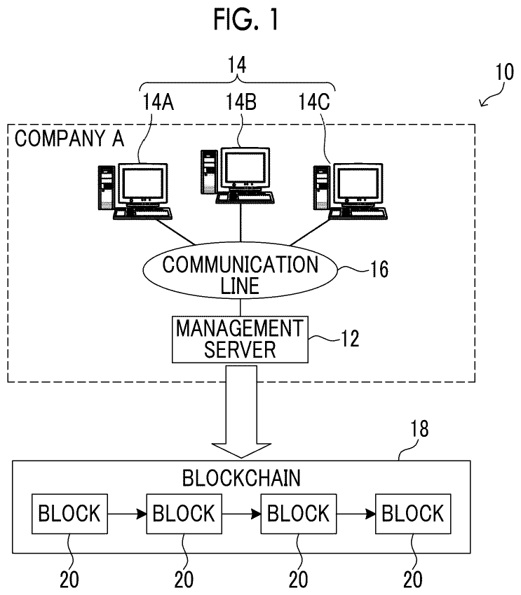

In the present embodiment, an information processing system in which a management server as an example of an information processing apparatus and a client computer are connected to each other via a communication line such as various networks will be described as an example. FIG. 1 is a block diagram illustrating an example of an overall configuration of an information processing system 10 according to the present embodiment.

As illustrated in FIG. 1, the information processing system 10 according to the present embodiment includes the management server 12 and a plurality of client computers 14 (14A, 14B, and 14C). The management server 12 and the client computer 14 are connected to each other via a communication line 16 such as a local area network (LAN), a wide area network (WAN), the Internet, and an intranet. The management server 12 and the client computer 14 can transmit and receive various types of data to and from each other via the communication line 16. It should be noted that, in FIG. 1, a case where three client computers 14 are provided is illustrated, but one or two client computers 14 may be provided, or four or more client computers 14 may be provided. In addition, a case where one management server 12 is provided is illustrated, but a plurality of management servers 12 may be provided.

In the present embodiment, the management server 12 performs writing to the blockchain 18 in response to a registration request for the blockchain 18 made from the client computer 14 to the management server 12.

The blockchain 18 is formed by connecting the blocks 20 sequentially like a chain. The block 20 is transactions (transaction data) corresponding to a predetermined data capacity, and is transaction data aggregated into a certain amount to which meta-information such as a timestamp (date) is added.

Meta-information such as a hash value and a nonce is added to each block 20 in addition to the timestamp. In each block 20, a previous block and a subsequent block are linked in a certain rule like a chain based on the information. The transactions are accumulated in real time and are bundled as the block 20 periodically. The block 20 including the transactions is held in each node constituting the blockchain 18, and even in a case where any node is tampered with, the tampering is rectified since other nodes hold correct information. The hash value is derived by using a special encryption technology called a hash function. A random value is derived as the nonce such that the leading digits of the hash value are 0. Each node constituting the blockchain 18 may or may not include the management server 12.

It is assumed that the blockchain 18 and a user who uses the blockchain 18 are present. The user of the blockchain 18 writes to or refers to the blockchain irregularly.

In addition, for example, as illustrated in FIG. 1, the information processing system 10 according to the present embodiment will be described as being provided in Company A, and each client computer 14 is operated by a user belonging to Company A.

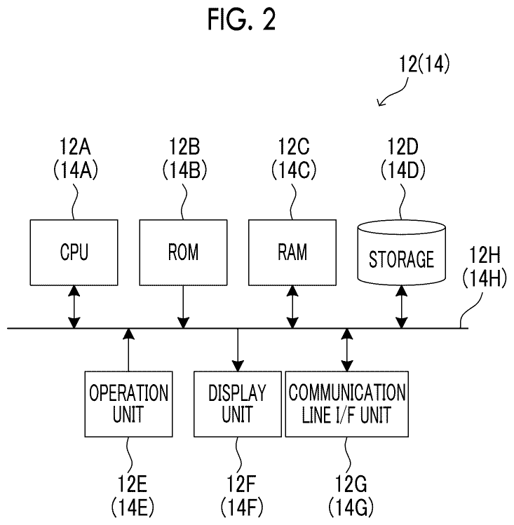

Subsequently, a main configuration of an electric system of the management server 12 and the client computer 14 of the information processing system 10 according to the present embodiment will be described. FIG. 2 is a block diagram illustrating a main configuration of the electric system of the management server 12 and the client computer 14 in the information processing system 10 according to the present embodiment. Since the management server 12 and the client computer 14 have a general computer configuration, the management server 12 will be described as a representative below.

As illustrated in FIG. 2, the management server 12 according to the present embodiment comprises a CPU 12A as an example of a processor, a ROM 12B, a RAM 12C, a storage 12D, an operation unit 12E, a display unit 12F, and a communication line interface (I/F) unit 12G. The CPU 12A controls the overall operation of the management server 12. The ROM 12B stores various control programs, various parameters, and the like in advance. The RAM 12C is used as a work area or the like in a case where various programs are executed by the CPU 12A. The storage 12D stores various types of data, application programs such as an update processing program of the blockchain 18, and the like. The operation unit 12E is used to input various types of information. The display unit 12F is used to display various types of information. The communication line I/F unit 12G is connected to the communication line 16 and transmits and receives various types of data to and from other apparatuses connected to the communication line 16. In addition, the communication line I/F unit 12G may be configured to be capable of directly communicating with each apparatus using various well-known wireless communications. Each unit of the management server 12 described above is electrically connected to each other by a system bus 12H. In the management server 12 according to the present embodiment, the storage 12D is applied as a storage unit, but as an example of the storage, a non-volatile storage unit such as a hard disk drive (HDD) or a flash memory is applied.

With the above configuration, the management server 12 according to the present embodiment executes, by the CPU 12A, access to the ROM 12B, the RAM 12C, and the storage 12D, acquisition of various types of data via the operation unit 12E, and display of various types of information on the display unit 12F. In addition, the management server 12 executes control of transmission and reception of communication data via the communication line I/F unit 12G, by the CPU 12A.

The information processing system 10 according to the present embodiment performs processing of making it difficult for others to predict an actual frequency of use by showing an “apparent frequency of use” of the blockchain 18 of the user in a case where any user including an individual, a company, a country, or the like uses the blockchain 18.

Specifically, the management server 12 checks an update command of the blockchain 18 at each predetermined time, and in a case where the update command is checked when the predetermined time has elapsed, generates a transaction based on the update command and adds the transaction to the blockchain 18. On the other hand, in a case where the update command is not checked even after the predetermined time has elapsed, the management server 12 performs processing of generating a dummy transaction and adding the generated dummy transaction to the blockchain 18.

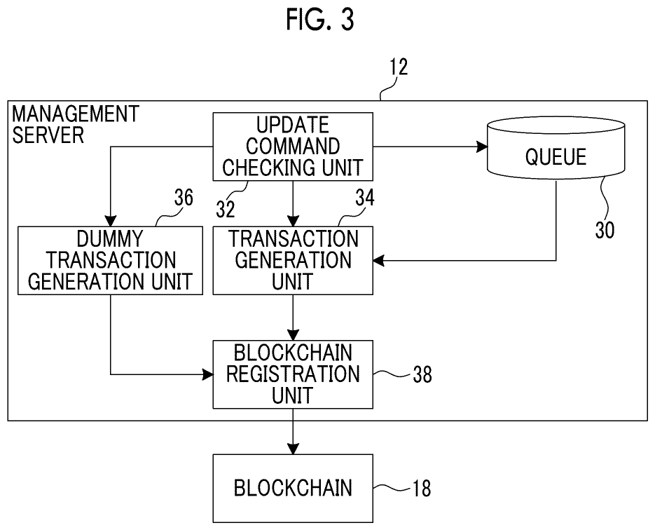

Specifically, the management server 12 has functions illustrated in FIG. 3 by loading the program stored in the ROM 12B into the RAM 12C and executing the program by the CPU 12A. FIG. 3 is a functional block diagram illustrating a functional configuration of the management server 12 of the information processing system 10 according to the present embodiment.

That is, the management server 12 has functions of a queue 30, an update command checking unit 32, a transaction generation unit 34, a dummy transaction generation unit 36, and a blockchain registration unit 38.

The queue 30 is a storage area set in advance in the storage 12D, stores the update commands transmitted from the client computer 14 in the order of reception, and extracts the update commands in the order of storage. The update command is a request to add a transaction including a key and a value corresponding to the key to the blockchain 18. For example, examples of the key include items such as a name and an age, and examples of the value corresponding to the key include a value of “Taro Yamada” in a case where the key is the name and a value of “27 years old” in a case where the key is the age.

The update command checking unit 32 checks whether or not the update command from the client computer 14 of the user is stored in the queue 30. In addition, the update command checking unit 32 has a timer that counts an elapsed time from the writing to the blockchain 18, measures the elapsed time by the timer, and compares the elapsed time with a predetermined time to determine whether or not the predetermined time has elapsed. In a case where the update command is stored in the queue 30 in a case where the predetermined time has elapsed, the update command checking unit 32 outputs an instruction to generate the transaction to the transaction generation unit 34. On the other hand, in a case where the update command is not stored in the queue 30 even after the predetermined time has elapsed, the update command checking unit 32 outputs an instruction to generate the dummy transaction to the dummy transaction generation unit 36. The predetermined time may be a constant or may be a time range that is not a constant. In addition, the predetermined time does not need to be constant, and may be changed by the user at any time. In addition, the predetermined time does not necessarily need to be determined by the user, and may be determined based on some algorithm.

The transaction generation unit 34 generates the transaction based on the update command, and outputs the generated transaction to the blockchain registration unit 38.

The dummy transaction generation unit 36 generates the dummy transaction, and outputs the generated dummy transaction to the blockchain registration unit 38. As the dummy transaction, a transaction of a random value or a fictional transaction content is generated as the dummy transaction. As an example of the content of the dummy transaction, for example, in a case where the user writes a hash value to the blockchain 18, a random hash value may also be written as the dummy content. In addition, in a case of remittance of the cryptocurrency or the like, a dummy account may be created, and a transaction for remitting to the dummy account may be created.

The blockchain registration unit 38 writes the transaction generated by the transaction generation unit 34 or the dummy transaction generated by the dummy transaction generation unit 36 to the blockchain 18.

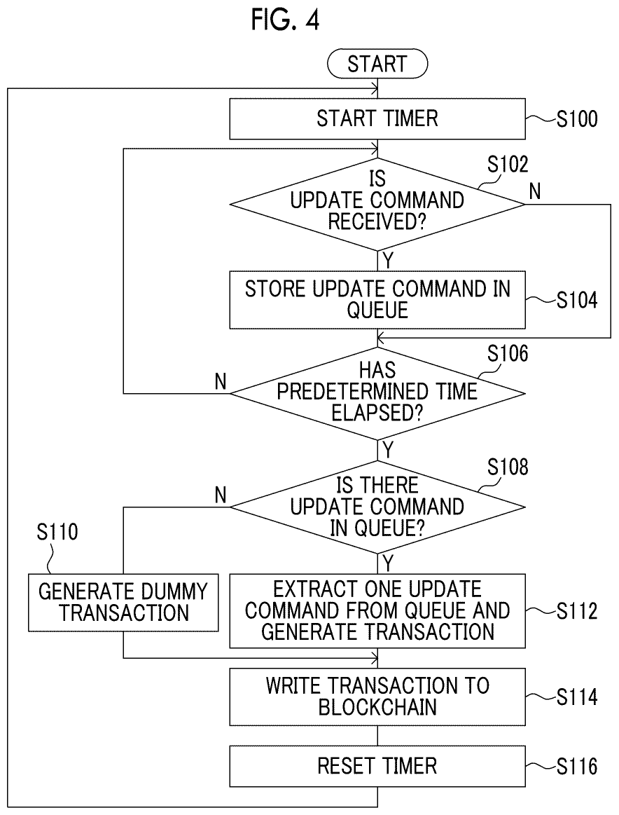

Subsequently, in the information processing system 10 according to the present embodiment configured as described above, specific processing of making it difficult for others to predict an actual frequency of use by showing the frequency of use of the blockchain 18 of the user as an “apparent frequency of use” will be described. FIG. 4 is a diagram illustrating an example of a flow of the update processing of the blockchain 18 performed by the management server 12 of the information processing system 10 according to the present embodiment. The processing in FIG. 4 is started, for example, in a case where the information processing system 10 is activated, and is ended in a case where the information processing system 10 is stopped.

In step S100, the CPU 12A starts a timer for counting the indicated elapsed time and proceeds to step S102.

In step S102, the CPU 12A determines whether or not the update command for adding the information to the blockchain 18 is received. In the determination, the update command checking unit 32 checks the update command for adding the information from the client computer 14 of the user to the blockchain 18, and in a case where the update command is checked and the determination is affirmative, the process proceeds to step S104, and in a case where the update command is not checked and the determination is negative, the process proceeds to step S106.

In step S104, the CPU 12A stores the update command in the queue 30 and proceeds to step S106. That is, the update command checking unit 32 stores the update command received from the client computer 14 in the queue 30.

In step S106, the CPU 12A determines whether or not the predetermined time has elapsed. In a case where the determination is negative, the process returns to step S102 and repeats the above-described process, and in a case where the determination is affirmative, the process proceeds to step S108.

In step S108, the CPU 12A determines whether or not there is the update command in the queue 30. In a case where the update command is not stored in the queue 30 and the determination is negative, the process proceeds to step S110, and in a case where the update command is stored in the queue 30 and the determination is affirmative, the process proceeds to step S112.

In step S110, the CPU 12A generates the dummy transaction and proceeds to step S114. That is, the dummy transaction generation unit 36 generates the dummy transaction and outputs the generated dummy transaction to the blockchain registration unit 38.

On the other hand, in step S112, the CPU 12A extracts one update command from the queue 30, generates the transaction, and proceeds to step S114. That is, the transaction generation unit 34 generates the transaction based on the update command extracted from the queue 30 and outputs the generated transaction to the blockchain registration unit 38.

In step S114, the CPU 12A writes the transaction to the blockchain 18 and proceeds to step S116. That is, the blockchain registration unit 38 writes the transaction generated by the transaction generation unit 34 or the dummy transaction generated by the dummy transaction generation unit 36 to the blockchain 18.

In step S116, the CPU 12A resets the timer, returns to step S100, and repeats the above-described processing.

As described above, in the information processing system 10 according to the present embodiment, the writing of the transaction or the dummy transaction based on the update command to the blockchain is performed at each predetermined time, so that the frequency of use of the blockchain 18 can be made to be an “apparent frequency of use”. As a result, it is possible to make it difficult for others to predict the actual frequency of use.

In the above-described embodiment, the example has been described in which the management server 12 of the information processing system 10 of Company A writes the transaction to the blockchain 18, but the present disclosure is not limited thereto. For example, an organization other than a company may be applied, or the update processing method of the blockchain 18 according to the present disclosure may be applied to a form in which the client computer 14 of an individual writes the transaction to the blockchain 18.

In addition, various types of processing executed by the CPU by executing software (program) in the above-described embodiment may be executed by a computer equipped with various processors other than the CPU. In this case, the examples of the processors include a programmable logic device (PLD) such as a field-programmable gate array (FPGA) having a circuit configuration changeable after manufacturing, a dedicated electric circuit such as an application specific integrated circuit (ASIC) that is a processor having a circuit configuration dedicatedly designed to execute specific processing, and the like. The various types of processing may be executed by one of the various processors or may be executed by a combination of two or more processors of the same kind or different kinds (for example, a plurality of FPGAs and a combination of a CPU and an FPGA). Furthermore, the hardware structures of the various processors are more specifically electrical circuitry where circuit elements, such as semiconductor elements, are combined.

Further, in the above embodiment, an aspect in which various programs are stored (installed) in the ROM 12 in advance has been described. However, the present disclosure is not limited thereto. Various programs may be provided in a form of being recorded in a recording medium such as a compact disk read only memory (CD-ROM), a digital versatile disk read only memory (DVD-ROM), and a Universal Serial Bus (USB) memory. In addition, the various programs may be provided in a form of being downloaded from an external information processing apparatus or the like via a network.

In addition, the configuration, the operation, and the like of the information processing system 10 described in the above-described embodiment are merely examples, and it goes without saying that the configuration, the operation, and the like can be changed according to the situation within a range not departing from the gist of the present disclosure.

The following supplementary notes are further disclosed with respect to the above embodiment.

### Supplementary Note 1

A blockchain update processing method executed by a computer, the method comprising:
checking an update command of a blockchain at each time set in advance;
generating a transaction based on the update command and adding the transaction to the blockchain in a case where the update command is checked when the time elapses;
generating a dummy transaction in a case where the update command is not checked even after the time elapses; and
adding the generated dummy transaction to the blockchain.

### Supplementary Note 2

The blockchain update processing method according to Supplementary Note 1, in which the computer measures an elapsed time and compares the elapsed time with the time to determine the elapse of the time.

### Supplementary Note 3

The blockchain update processing method according to Supplementary Note 1 or 2, in which the update command is a request to add a transaction including a key and a value corresponding to the key to the blockchain.

### Supplementary Note 4

The blockchain update processing method according to any one of Supplementary Notes 1 to 3, in which the computer generates a random value or a fictional transaction content as the dummy transaction.

### Supplementary Note 5

An information processing apparatus comprising:
a processor,
in which the processor is configured to:
   check an update command of a blockchain at each time set in advance;
   generate a transaction based on the update command and add the transaction to the blockchain in a case where the update command is checked when the time elapses;
   generate a dummy transaction in a case where the update command is not checked even after the time elapses; and
   add the generated dummy transaction to the blockchain.

### Supplementary Note 6

An information processing system comprising:
the information processing apparatus according to Supplementary Note 5, and
a client computer that transmits the update command to the information processing apparatus.

### Supplementary Note 7

A program for causing a computer to execute a process comprising:
checking an update command of a blockchain at each time set in advance;
generating a transaction based on the update command and adding the transaction to the blockchain in a case where the update command is checked when the time elapses;
generating a dummy transaction in a case where the update command is not checked even after the time elapses; and
adding the generated dummy transaction to the blockchain.

The disclosure of JP2023-199420 is incorporated in the present specification by reference in its entirety. All documents, patent applications, and technical standards disclosed in the present specification are incorporated in the present specification by reference to the same extent as in a case where each of the documents, patent applications, and technical standards are specifically and individually indicated to be incorporated by reference.

What is claimed is:

1. A blockchain update processing method executed by a computer, the method comprising:
checking an update command of a blockchain at each predetermined time;
generating a transaction based on the update command and adding the transaction to the blockchain in a case where the update command is checked when the time elapses;
generating a fictional transaction content as a dummy transaction in a case where the update command is not checked even after the time elapses; and
adding the generated dummy transaction to the blockchain.

2. The blockchain update processing method according to claim 1,
wherein the computer measures an elapsed time and compares the elapsed time with the time to determine the elapse of the time.

3. The blockchain update processing method according to claim 1,
wherein the update command is a request to add a transaction including a key and a value corresponding to the key to the blockchain.

4. An information processing apparatus comprising:
a processor,
the processor being configured to:
check an update command of a blockchain at each predetermined time;
generate a transaction based on the update command and add the transaction to the blockchain in a case where the update command is checked when the time elapses;
generate a fictional transaction content as a dummy transaction in a case where the update command is not checked even after the time elapses; and
add the generated dummy transaction to the blockchain.

5. An information processing system comprising:
the information processing apparatus according to claim 4; and
a client computer that transmits the update command to the information processing apparatus.

6. A non-transitory computer-readable storage medium storing a program for causing a computer to execute a process comprising:
checking an update command of a blockchain at each predetermined time;
generating a transaction based on the update command and adding the transaction to the blockchain in a case where the update command is checked when the time elapses;
generating a fictional transaction content as a dummy transaction in a case where the update command is not checked even after the time elapses; and
adding the generated dummy transaction to the blockchain.
